(19) United States
(12) Patent Application Publication
(10) Pub. No.: US 2009/0259756 A1
(43) Pub. Date: Oct. 15, 2009

(54) TRANSMITTING MEDIA STREAM BURSTS

(75) Inventors: Kent Karlsson, San Francisco, CA (US); Ola Hallmarker, Hagersten (SE); Martin Linderoth, Arsta (SE)

Correspondence Address: Weaver Austin Villeneuve & Sampson LLP, P.O. BOX 70250, OAKLAND, CA, 94612-0250, US

(73) Assignee: MOBITV, INC., Emeryville, CA (US)

(21) Appl. No.: 12/101,899

(22) Filed: Apr. 11, 2008

(51) Int. Cl. G06F 15/16

(52) U.S. Cl. 709/228

(57) ABSTRACT

Mechanisms are provided to transmit media stream bursts upon recognizing that a device buffer is low or empty. In particular examples, a content server transmits 6 seconds of video in 2 seconds in order to quickly replenish a device buffer so that the device can start playback sooner. Content server buffers for particular channels can be prefilled even before any stream is requested for that channel. The content server can transmit at a higher bit rate for a short period of time or alternatively can switch to transmitting a lower quality stream for a short period of time. A media stream burst can be provided without disrupting system operation or requiring client rebuffering.

### TECHNICAL FIELD

The present disclosure relates to transmitting media streams.

### DESCRIPTION OF RELATED ART

Protocols such as the Real-Time Transport Protocol (RTP) are used to transport video and audio data over networks. A separate session is used to carry each content stream such as a video or audio stream. RTP specifies a standard packet format that is used to carry video and audio data such as Moving Pictures Expert Group (MPEG) video data including MPEG-2 and MPEG-4 video frames. In many instances, multiple frames are included in a single RTP packet. The MPEG frames themselves may be reference frames or may be frames encoded relative to a reference frame.

Conventional techniques and mechanisms allow a content server to transmit a media stream to a client device such as a mobile device. However, mechanisms for transmitting streams efficiently and effectively are limited. Consequently, it is desirable to provide improved techniques and mechanisms for transmitting media streams from content servers to client devices.

### BRIEF DESCRIPTION OF THE DRAWINGS

The disclosure may best be understood by reference to the following description taken in conjunction with the accompanying drawings, which illustrate particular embodiments.

FIG. 1 illustrates an exemplary system for use with embodiments of the present invention.

FIG. 2 illustrates one example of a Real-Time Transport Protocol (RTP) packet.

FIG. 3 illustrates one example of an RTP stream.

FIG. 4 illustrates one example of system that can use buffer burst.

FIG. 5 illustrates one example of bursting with a low bit rate stream.

FIG. 6 illustrates one example of performing buffer burst.

FIG. 7 illustrates one example of a system for processing media streams.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of the Real-Time Transport Protocol (RTP) and the Real-Time Streaming Protocol (RTSP). However, it should be noted that the techniques of the present invention apply to a variations of RTP and RTSP. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Mechanisms are provided to transmit media stream bursts upon recognizing that a device buffer is low or empty. In particular examples, a content server transmits 6 seconds of video in 2 seconds in order to quickly replenish a device buffer so that the device can start playback sooner. Content server buffers for particular channels can be prefilled even before any stream is requested for that channel. The content server can transmit at a higher bit rate for a short period of time or alternatively can switch to transmitting a lower quality stream for a short period of time. A media stream burst can be provided without disrupting system operation or requiring client rebuffering.

### Example Embodiments

A variety of mechanisms are used to deliver media streams to devices. In particular examples, a client establishes a session such as a Real-Time Streaming Protocol (RTSP) session. A server computer receives a connection for a media stream, establishes a session, and provides a media stream to a client device. The media stream includes packets encapsulating frames such as Moving Pictures Expert Group (MPEG) frames. The MPEG frames themselves may be key frames or differential frames. The specific encapsulation methodology used by the server depends on the type of content, the format of that content, the format of the payload, the application and transmission protocols being used to send the data. After the client device receives the media stream, the client device decapsulates the packets to obtain the MPEG frames and decodes the MPEG frames to obtain the actual media data.

In many instances, a server computer obtains media data from a variety of sources, such as media libraries, cable providers, satellite providers, and processes the media data into MPEG frames such as MPEG-2 or MPEG-4 frames. In particular examples, a server computer may encode six media streams of varying bit rates for a particular channel for distribution to a variety of disparate devices. A client device typically requests a media stream and will not begin playback of a media stream until a certain amount of media stream data has been received. In particular examples, a mobile device will not play video until at least five seconds of video has been buffered. The buffering is performed to prevent buffer starvation. Even with playback delays however, buffer starvation can still occur. According to various embodiments, starvation will cause a client application to buffer a certain amount of media before continuing playback leading to disruption in the viewing experience.

According to various embodiments, a content server sends a burst of data to a client when a client buffer is low. For example, if a client is initially connecting to a content server or if the content server somehow detects that the client device buffer is low or empty, a content server transmits more seconds of data to the client so that the client can start playback or recover from starvation sooner. In particular instances, the content server bursts 5 seconds worth of data in 1 or 2 seconds by transmitting data at a bit rate 2-4 times the normal bit rate. In other examples, the content server transmits 5 seconds worth of a lower quality media stream in 1 or 2 seconds and switches back to a normal quality media stream as soon as buffer levels rise at the client device.

In particular embodiments, a live media stream can be replaced with a lower bit rate stream to allow more efficient client playback. According to various embodiments, a content server receives an indication that the client buffer level is low or empty. The content server obtains a stream having lower bandwidth and replaces the live stream with the lower bandwidth stream. The replacement occurs without interrupting the user experience and does not require any new buffering or new session on the part of the client. According to various embodiments, all or selected channel buffers at a content server are prefilled or prewarmed even before any device has requested a channel. In particular example embodiments, once a media stream has been requested, the corresponding channel buffer is filled at the content server. However, channel buffers corresponding to media streams not yet requested are typically not prefilled or prewarmed. Playback can be delayed while the content server channel buffers are filled. Consequently, the techniques and mechanisms of the present invention contemplate prefilling channel buffers. In some instances, all channel buffers are prefilled. In other instances, selected channel buffers are prefilled.

Sequence information is also maintained and/or modified to allow seamless client device operation. Timing and sequence information in an RTP stream is preserved. A client device can not distinguish between a live stream modified by a content server and an original live stream.

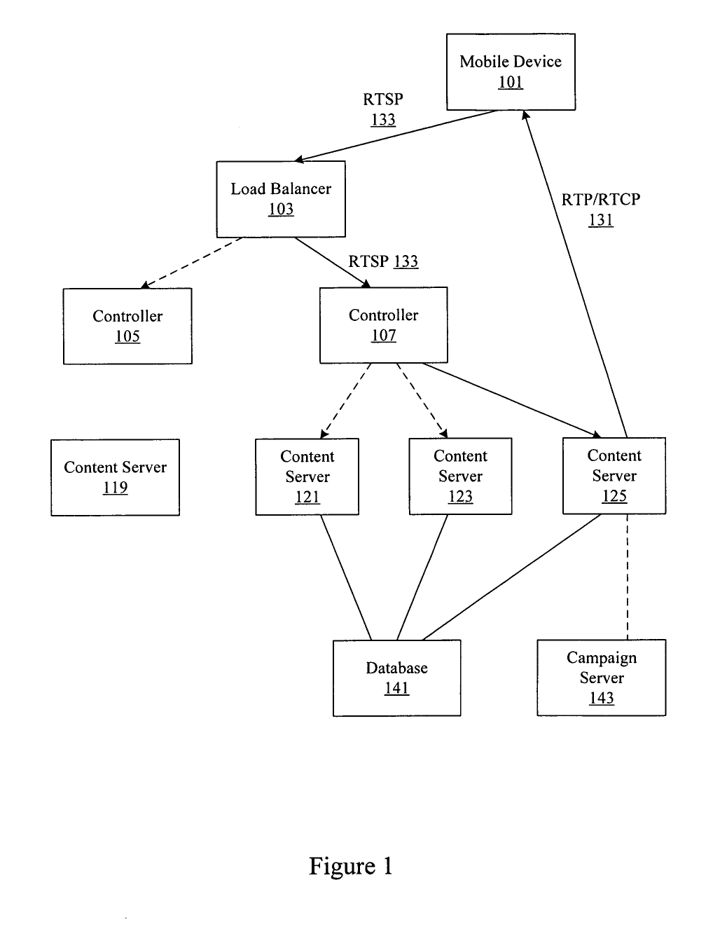

FIG. 1 is a diagrammatic representation illustrating one example of a system that can use the techniques and mechanisms of the present invention. According to various embodiments, content servers 119, 121, 123, and 125 are configured to provide media content to a mobile device 101 using protocols such as RTP and RTCP. Although a mobile device 101 is shown, it should be recognized that other devices such as set top boxes and computer systems can also be used. In particular examples, the content servers 119, 121, 123, and 125 can themselves establish sessions with mobile devices and stream video and audio content to mobile devices. However, it is recognized that in many instances, a separate controller such as controller 105 or controller 107 can be used to perform session management using a protocol such as RTSP. It is recognized that content servers require the bulk of the processing power and resources used to provide media content mobile devices. Session management itself may include far fewer transactions. Consequently, a controller can handle a far larger number of mobile devices than a content server can. In some examples, a content server can operate simultaneously with thousands of mobile devices, while a controller performing session management can manage millions of mobile devices simultaneously.

By separating out content streaming and session management functions, a controller can select a content server geographically close to a mobile device 101. It is also easier to scale, as content servers and controllers can simply be added as needed without disrupting system operation. A load balancer 103 can provide further efficiency during session management using RTSP 133 by selecting a controller with low latency and high throughput.

According to various embodiments, the content servers 119, 121, 123, and 125 have access to a campaign server 143. The campaign server 143 provides profile information for various mobile devices 101. In some examples, the campaign server 143 is itself a content server or a controller. The campaign server 143 can receive information from external sources about devices such as mobile device 101. The information can be profile information associated with various users of the mobile device including interests and background. The campaign server 143 can also monitor the activity of various devices to gather information about the devices. The content servers 119, 121, 123, and 125 can obtain information about the various devices from the campaign server 143. In particular examples, a content server 125 uses the campaign server 143 to determine what type of media clips a user on a mobile device 101 would be interested in viewing.

According to various embodiments, the content servers 119, 121, 123, and 125 are also receiving media streams from content providers such as satellite providers or cable providers and sending the streams to devices using RTP 131. In particular examples, content servers 119, 121, 123, and 125 access database 141 to obtain desired content that can be used to supplement streams from satellite and cable providers. In one example, a mobile device 101 requests a particular stream. A controller 107 establishes a session with the mobile device 101 and the content server 125 begins streaming the content to the mobile device 101 using RTP 131. In particular examples, the content server 125 obtains profile information from campaign server 143.

In some examples, the content server 125 can also obtain profile information from other sources, such as from the mobile device 101 itself. Using the profile information, the content server can determine whether a client device would support a burst of data. For example, the content server could determine that the client device has a particular buffer size and reports when the buffer is low or empty. When the client device supports buffer bursts, the content server can transmit available data at a higher bit rate to the client device when the client buffer is low or empty. In some instances, a content server buffer for a particular channel will be empty and nothing can be transmitted to the client. However, if the content server buffer for the particular channel has data available, a burst of data can be transmitted to replenish the client buffer. In a particular example, 8 seconds of video data is transmitted in a short amount of time. Extra packets can simply be transmitted. However, a lower quality stream selected from the same channel or from a database can also be transmitted to replenish the client buffer.

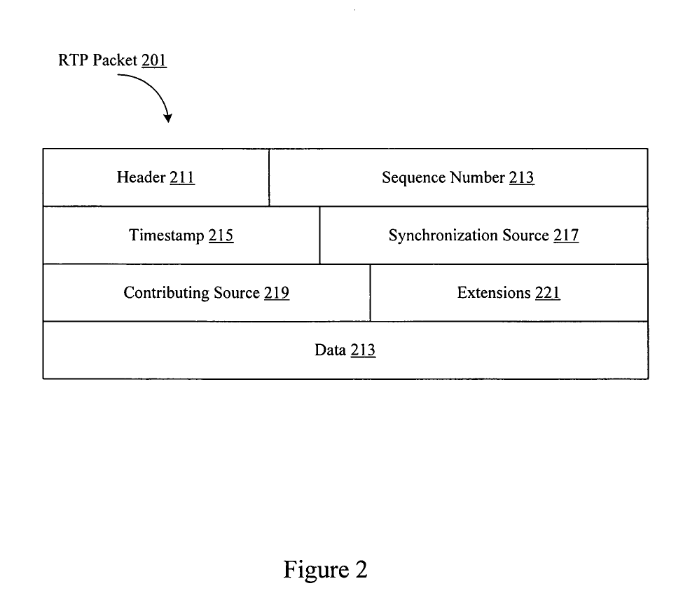

FIG. 2 illustrates one example of an RTP packet. An RTP packet 201 includes a header 211. According to various embodiments, the header 211 includes information such as the version number, amount of padding, protocol extensions, application level, payload format, etc. The RTP packet 201 also includes a sequence number 213. Client applications receiving RTP packets expect that the sequence numbers for received packets be unique. If different packets have the same sequence number, erroneous operation can occur. RTP packets also have a timestamp 215 that allows jitter and synchronization calculations. Fields 217 and 219 identify the synchronization source and the contributing source. Extensions are provided in field 221.

According to various embodiments, data 231 holds actual media data such as MPEG frames. In some examples, a single RTP packet 201 holds a single MPEG frame. In many instances, many RTP packets are required to hold a single MPEG frame. In instances where multiple RTP packets are required for a single MPEG frame, the sequence numbers change across RTP packets while the timestamp 215 remains the same across the different RTP packets. Different MPEG frames include I-frames, P-frames, and B-frames. I-frames are intraframes coded completely by itself. P-frames are predicted frames which require information from a previous I-frame or P-frame. B-frames are bi-directionally predicted frames that require information from surrounding I-frames and P-frames.

Because different MPEG frames require different numbers of RTP packets for transmission, two different streams of the same time duration may require different numbers of RTP packets for transmission. Simply replacing a clip with another clip would not work, as the clips may have different numbers of RTP packets and having different impacts on the sequence numbers of subsequent packets.

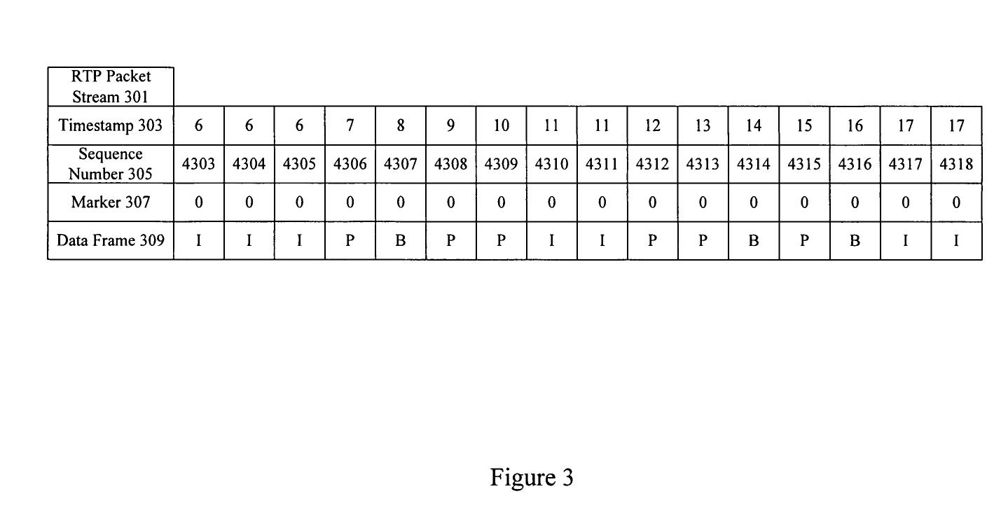

FIG. 3 illustrates one example of an RTP packet stream. An RTP packet stream 301 includes individual packets having a variety of fields and payload data. According to various embodiments, the fields include a timestamp 303, sequence 505, marker 307, etc. The packets also include payload data 309 holding MPEG frames such as I, P, and B-frames. Timestamps for different packets may be the same. In particular examples, several packets carrying portions of the same I-frame have the same time stamp. However, sequence numbers are different for each packet. Marker bits 307 can be used for different purposes, such as signaling the starting point of an advertisement.

According to various embodiments, packets with sequence numbers 4303, 4304, and 4305 carrying potions of the same I-frame and have the same timestamp of 6. Packets with sequence numbers 4306, 4307, 4308, and 4309 carry P, B, P, and P-frames and have timestamps of 7, 8, 9, and 10 respectively. Packets with sequence numbers 4310 and 4311 carry different portions of the same I-frame and both have the same timestamp of 11. Packets with sequence numbers 4312, 4313, 4314, 4315, and 4316 carry P, P, B, P, and B-frames respectively and have timestamps 12, 13, 14, 15, and 16. It should be noted that the timestamps shown in FIG. 3 are merely representational. Actual timestamps can be computed using a variety of mechanisms.

For many audio encodings, the timestamp is incremented by the packetization interval multiplied by the sampling rate. For example, for audio packets having 20 ms of audio sampled at 8,000 Hz, the timestamp for each block of audio increases by 160. The actual sampling rate may also differ slightly from this nominal rate. For many video encodings, the timestamps generated depend on whether the application can determine the frame number. If the application can determine the frame number, the timestamp is governed by the nominal frame rate. Thus, for a 30 f/s video, timestamps would increase by 3,000 for each frame. If a frame is transmitted as several RTP packets, these packets would all bear the same timestamp. If the frame number cannot be determined or if frames are sampled a periodically, as is typically the case for software codecs, the timestamp may be computed from the system clock

While the timestamp is used by a receiver to place the incoming media data in the correct timing order and provide playout delay compensation, the sequence numbers are used to detect loss. Sequence numbers increase by one for each RTP packet transmitted, timestamps increase by the time “covered” by a packet. For video formats where a video frame is split across several RTP packets, several packets may have the same timestamp. For example, packets with sequence numbers 4317 and 4318 have the same timestamp 17 and carry portions of the same I-frame.

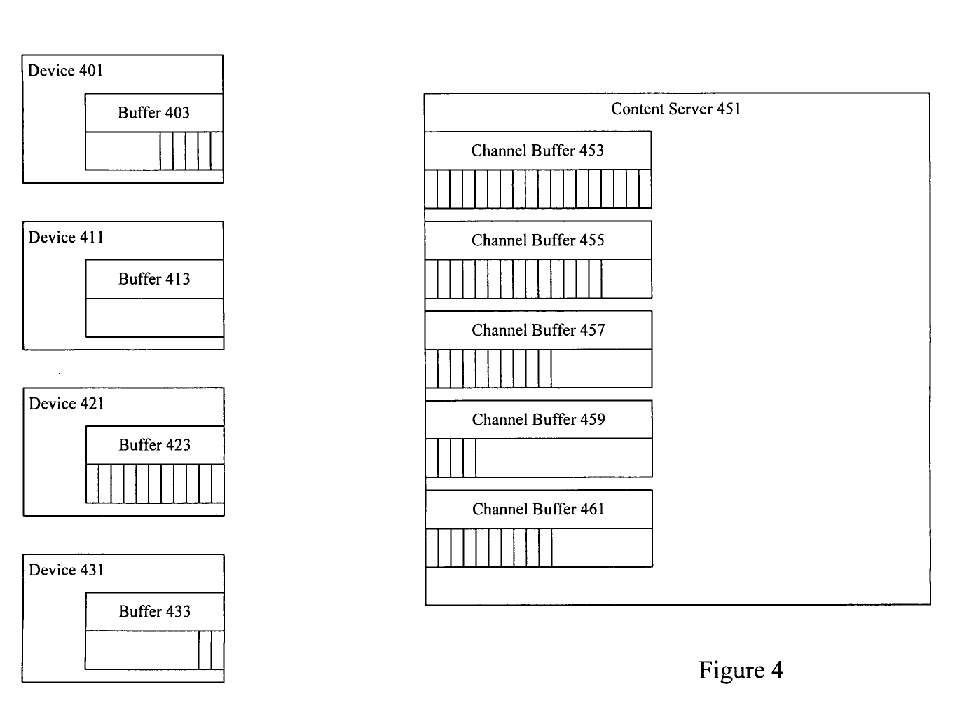

FIG. 4 illustrates one example of content server buffers. According to various embodiments, devices 401, 411, 421, and 431 have individual buffers 403, 413, 423, and 433. Content server 451 includes channel buffers 453, 455, 457, 459, and 461. In particular embodiments, a content server 451 detects that a device has little or no data remaining in a buffer. A device such as a mobile device may have little or no data in a buffer when network conditions cause transmission delays and drop packets or when a device initially requests a media stream. To improve user experience, a content server 451 bursts available data for a requested stream to a device 411 having an low or empty buffer. In some examples, the content server 451 transmits data from channel buffer 455 to device 411 at double the usual transmission bit rate for a fixed number of seconds.

In other examples, the content server 451 transmits data from a low quality stream in channel buffer 453 to device 411. Transmitting a lower quality stream allows a buffer to be filled while maintaining the same transmission bit rate. For example, a stream in channel buffer 453 may be a 50 mbps stream while a stream in channel buffer 455 may be a 100 mbps stream. More frames from the lower quality stream can be transmitted to allow the device 411 to resume playback with decreased delay.

According to various embodiments, content server buffers may or may not be prefilled. In some examples, once a media stream has been requested, the corresponding channel buffer is filled at the content server. However, channel buffers corresponding to media streams not yet requested are typically not prefilled or prewarmed. Playback can be delayed while the content server channel buffers are filled. Consequently, the techniques and mechanisms of the present invention contemplate prefilling channel buffers. According to various embodiments, the content server channel buffers are prefilled using live streams from cable and satellite providers and continually refreshed with the most recent streaming data. In some instances, all channel buffers are prefilled. In other instances, selected channel buffers are prefilled and refreshed using satellite and cable media streams.

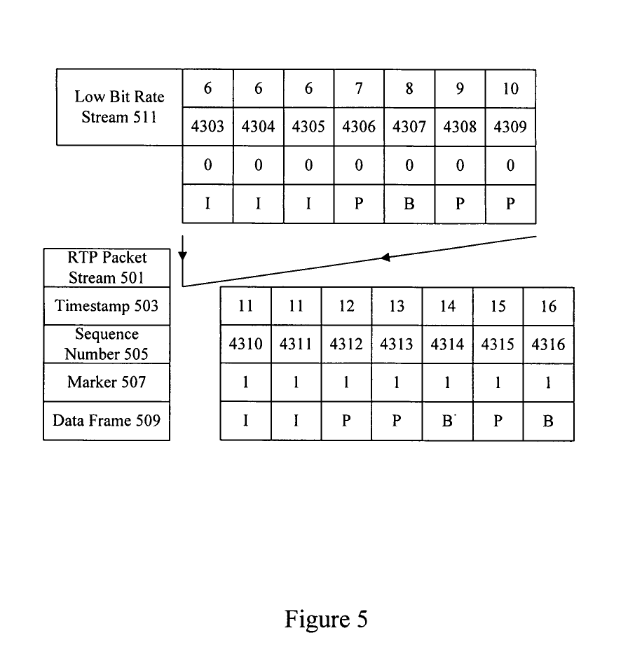

FIG. 5 illustrates one example of a mechanism to perform buffer burst. An RTP packet stream 501 includes individual packets having a variety of fields and payload data. According to various embodiments, the fields include a timestamp 503, sequence 505, marker 507, etc. The packets also include payload data 509 holding MPEG frames such as I, P, and B-frames. Timestamps for different packets may be the same. In particular examples, several packets carrying portions of the same I-frame have the same time stamp. However, sequence numbers are different for each packet. Marker bits 507 can be used for different purposes, such as signaling the starting point of an advertisement or the beginning and endpoints of a trailer.

According to various embodiments, upon detecting buffer starvation, a lower quality stream has sequence numbers 4303, 4304, and 4305 carrying potions of the same I-frame and have the same timestamp of 6. Packets with sequence numbers 4306, 4307, 4308, and 4309 carry P, B, P, and P-frames and have timestamps of 7, 8, 9, and 10 respectively. According to various embodiments, a content server transmits the lower bit rate stream 511.

A requested stream includes packets with sequence numbers 4310 and 4311 that carry different portions of the same I-frame and both have the same timestamp of 11. Packets with sequence numbers 4312, 4313, 4314, 4315, 4316 carry P, P, B, P, and B-frames respectively and have timestamps 12, 13, 14, 15, and 16. The spliced stream now ends at packet with sequence number 4309 carrying a P-frame. A B-frame is included in packet having sequence number 4307. It should be noted that B-frames sometimes may depend on information included in a subsequent I-frame which has been removed. Although having a few B-frames lacking reference frames is not extremely disruptive, it can sometimes be noticed. Therefore, the techniques of the present invention recognize that in some embodiments, the last packets left in a stream prior to splicing should be an I-frame or a P-frame.

Consequently, the content server maintains a current sequence number per RTP data stream and modified subsequent packets after removing and inserting streams. According to various embodiments, this operation is uniquely performed at a content server because the content server has information about individual mobile devices and also is able to know information about the sequence numbers of an entire content stream. A content provider may not know information about individual mobile devices, whereas a network device or network switch may not receive all data packets in a sequence. Some packets may have been dropped while others may have been transmitted on different paths.

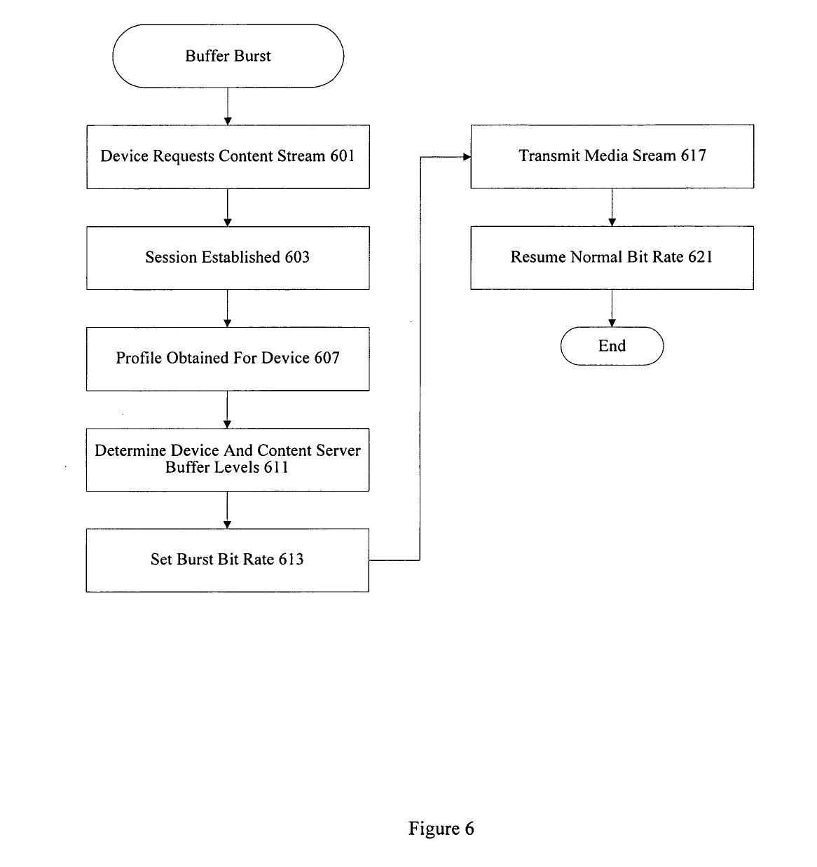

FIG. 6 is a flow process diagram illustrating one example of bursting data. At 601, a device requests a media stream. At 603, the device establishes a session with the content server. At 607, a profile is obtained for the device. According to various embodiments, establishing a session provides the content server with information about the buffer size of a device. The content server may also be provided with information about data burst support. In particular embodiments, the device provides information to the server about buffer levels when buffer levels are low or empty. At 611, the content server determines buffer levels for a requested media stream and buffer levels at a device. If the device has space and the content server buffer has media stream data, a burst bit rate is set at 613. In some examples, the burst bit rate may be two or three times the normal transmission bit rate. In other examples, the burst bit rate may be the same as the normal transmission bit rate, but a lower quality stream may be transmitted.

At 617, the media stream is transmitted at a higher rate. In some embodiments, a lower quality stream is transmitted at the same bit rate. At 621, after a few seconds of burst, the content server resumes transmitting at the normal transmission bit rate.

A variety of devices can be used with the techniques and mechanisms of the present invention. According to various embodiments, a content server includes a processor, memory, and a streaming interface. Specifically configured devices can also be included to allow rapid modification of sequence numbers.

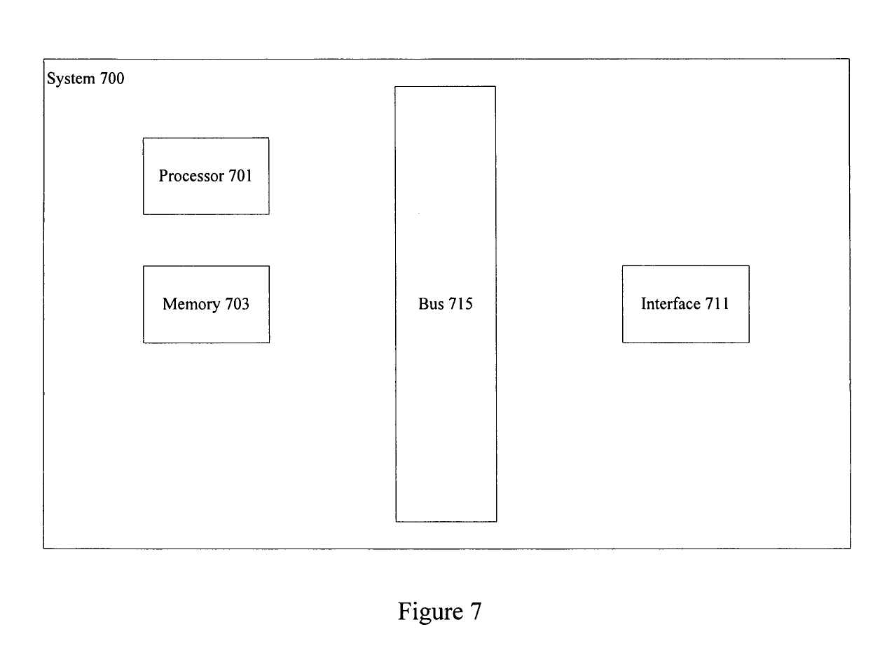

FIG. 7 illustrates one example of a content server that can perform data burst. According to particular embodiments, a system 700 suitable for implementing particular embodiments of the present invention includes a processor 701, a memory 703, an interface 711, and a bus 715 (e.g., a PCI bus or other interconnection fabric) and operates as a streaming server. When acting under the control of appropriate software or firmware, the processor 701 is responsible for modifying and transmitting live media data to a client. Various specially configured devices can also be used in place of a processor 701 or in addition to processor 701. The interface 711 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 700 is a content server that also includes a transceiver, streaming buffers, and a program guide database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 791 handles requests and responses for media content related transactions while a separate streaming server provides the actual media streams.

Although a particular content server 791 is described, it should be recognized that a variety of alternative configurations are possible. For example, some modules such as a report and logging module 753 and a monitor 751 may not be needed on every server. Alternatively, the modules may be implemented on another device connected to the server. In another example, the server 791 may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method, comprising:
establishing a session between a device and a content server to provide a media stream to the device;
determining a device buffer level and a content server buffer level for the media stream; and
transmitting x seconds of media stream to the device in y seconds, wherein x is greater than y.

2. The method of claim 1, wherein x seconds of media stream is transmitted to the device in y seconds by increasing the transmission bit rate.

3. The method of claim 1, wherein x seconds of media stream is transmitted to the device in y seconds by transmitting a lower bit rate version of the media stream.

4. The method of claim 3, wherein the lower bit rate version of the media stream is transmitting without rebuffering at the device.

5. The method of claim 3, wherein the lower bit rate version of the media stream is transmitting without establishing a new session with the device.

6. The method of claim 1, wherein a content server buffer corresponding to the media stream is prewarmed.

7. The method of claim 1, wherein a content server buffer corresponding to the media stream is filled before any request has been made for the media stream.

8. The method of claim 7, wherein a plurality of content server buffers corresponding to different versions of the same media stream are filled before any request has been made for the media stream.

9. The method of claim 1, wherein the device buffer level is determined to be empty at session startup.

10. The method of claim 1, wherein the device buffer level is determined to be low when the device signals the content server.

11. The method of claim 1, wherein the media stream is a Real-Time Transport Protocol (RTP) stream.

12. The method of claim 1, wherein the content server is connected over a network to a controller operable to establish a session with the device using a Real-Time Streaming Protocol (RTSP).

13. The method of claim 1, wherein the media stream comprises a plurality of packets holding I-frames, P-frames, and B-frames.

14. The method of claim 13, wherein the media stream transmits the lower bit rate version of the media stream without decoding payload data in the plurality of packets.

15. A system, comprising:
a controller operable to establishing a session between a device and a content server to provide a media stream to the device;
a processor operable to determine a device buffer level and a content server buffer level for the media stream; and
an interface operable to transmit x seconds of media stream to the device in y seconds, wherein x is greater than y.

16. The system of claim 15, wherein x seconds of media stream is transmitted to the device in y seconds by increasing the transmission bit rate.

17. The system of claim 15, wherein x seconds of media stream is transmitted to the device in y seconds by transmitting a lower bit rate version of the media stream.

18. The system of claim 17, wherein the lower bit rate version of the media stream is transmitting without rebuffering at the device.

19. The system of claim 17, wherein the lower bit rate version of the media stream is transmitting without establishing a new session with the device.

20. The system of claim 15, wherein a content server buffer corresponding to the media stream is prewarmed.

21. The system of claim 15, wherein a content server buffer corresponding to the media stream is filled before any request has been made for the media stream.

22. An apparatus, comprising:
means for establishing a session between a device and a content server to provide a media stream to the device;
means for determining a device buffer level and a content server buffer level for the media stream; and
means for transmitting x seconds of media stream to the device in y seconds, wherein x is greater than y.
